(19) United States
(12) Patent Application Publication
(10) Pub. No.: US 2009/0060317 A1
(43) Pub. Date: Mar. 5, 2009

(54) MASK DEFECT REPAIR THROUGH WAFER PLANE MODELING

(76) Inventor: William Volk, San Francisco, CA (US)

Correspondence Address: LNG/KLA 2 Joint Customer Number;C/O Luedeka, Neely & Graham, P.C., P.O. Box 1871, Knoxville, TN, 37901, US

(21) Appl. No.: 11/849,228

(22) Filed: Aug. 31, 2007

(51) Int. Cl. G06K 9/00

(52) U.S. Cl. 382/149

(57) ABSTRACT

Methods and apparatus relating to repair of mask defects through wafer plane modeling are described. In an embodiment, an updated edge location for a photomask is determined based on an image of the photomask and a comparison of contour of a corresponding wafer to physical design data of a corresponding device design. Other embodiments are also described.

### FIELD

The subject matter described herein generally relates to mask defect repairs. In one embodiment, some of the techniques described herein may be utilized to repair a mask defect through wafer plane modeling.

### BACKGROUND

When manufacturing integrated circuit (IC) devices, one or more photomasks may be used. Generally, a photomask may be an opaque plate with transparencies (or holes) that allow light to shine through in a defined pattern. In some implementations, photomasks may be fed into a photolithography stepper or scanner and individually selected for exposure, thereby defining one or more pattern layers for an IC device. Hence, photomask defects may result in defects in a corresponding IC device. To this end, photomasks with no detectable defects or limited defects may be essential to manufacturing of operational IC devices.

### SUMMARY

In accordance with some embodiments, techniques for repairing one or more mask defects are described. In an embodiment, the mask defect repair strategy may be determined based on wafer plane modeling that identifies contours of a corresponding wafer.

In one embodiment, an apparatus may include an image capture device to capture an image of a photomask. The apparatus may also include logic (e.g., one or more processors) to determine an updated edge location of the photomask based on the photomask image and a contour of a corresponding wafer.

In another embodiment, a method may acquire a photomask image. The method may further determine an updated edge location for the photomask based on the photomask image and a contour of a corresponding wafer.

Additional advantages, objects, and features of embodiments of the invention are set forth in part in the detailed description which follows. It is to be understood that both the foregoing general description and the following detailed description are merely exemplary of embodiments of the invention, and are merely intended to provide an overview or framework for understanding the nature and character of embodiments of the invention.

### BRIEF DESCRIPTION OF THE DRAWINGS

The accompanying drawings are included to provide further understanding of embodiments of the invention, illustrate various embodiments of the invention, and together with the description serve to explain the principles and operation of the invention. In the figures, the left-most digit(s) of a reference number identifies the figure in which the reference number first appears. The use of the same reference numbers in different figures indicates similar or identical items.

FIG. 1 illustrates a block diagram of an inspection system, according to an embodiment.

FIG. 2 is a flow diagram of a method to repair mask defects, according to an embodiment.

FIG. 3 illustrates a block diagram of computer system that may be utilized in various embodiments of the invention.

### DETAILED DESCRIPTION

In the following description, numerous specific details are set forth in order to provide a thorough understanding of embodiments of the invention. Embodiments of the invention may be practiced without some or all of these specific details. In other instances, well known process operations have not been described in detail in order not to unnecessarily obscure embodiments of the invention.

Also, reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

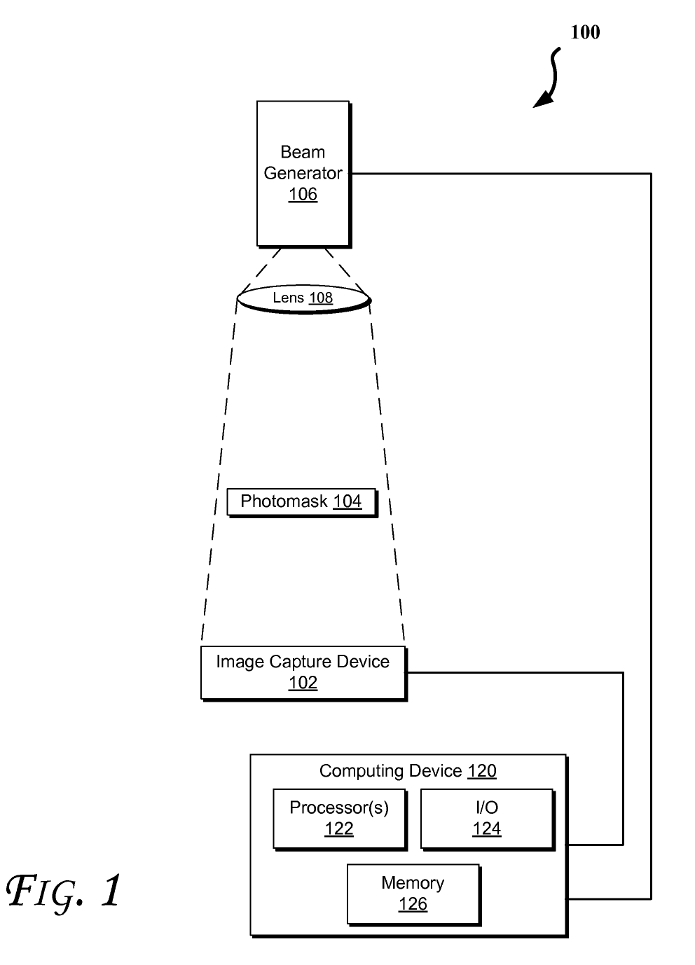

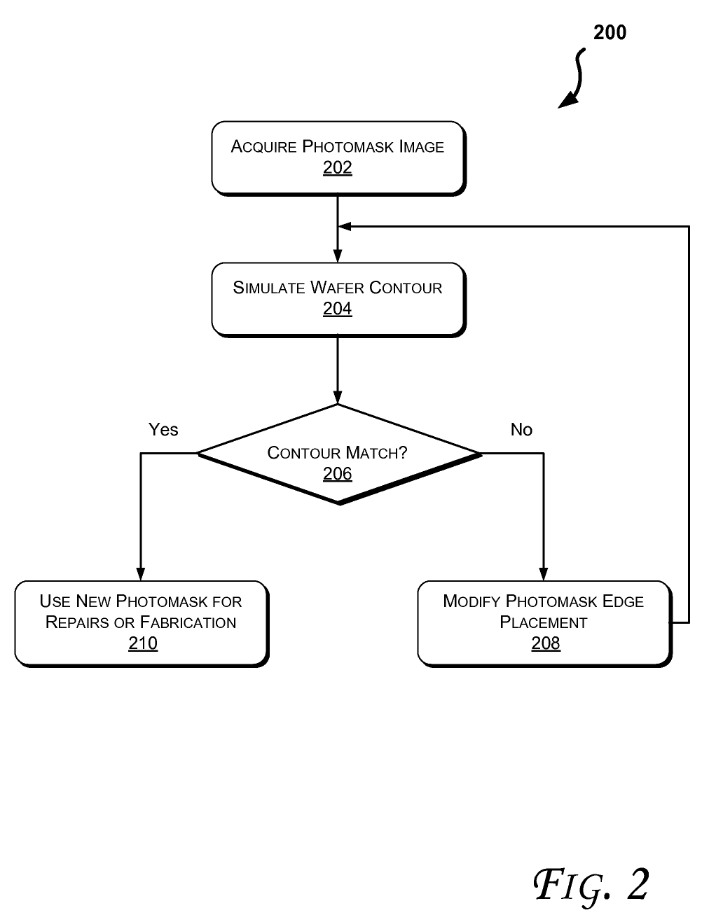

FIG. 1 illustrates a block diagram of an inspection system 100 in accordance with an embodiment of the invention. In various embodiments, the system 100 may be used to detect and/or repair photomask (which may be also referred to herein more generally as a “mask” or “reticle”) errors, such as discussed further herein with reference to FIG. 2, for example.

As shown in FIG. 1, the system 100 may include an image capture device 102 to capture an image of a photomask 104. The photomask 104 may be patterned by a pattern generating tool (not shown). The device 102 may capture an image of the photomask 104 using a beam generator 106 which may be any type of a beam generator such as an optical beam generator or an electron beam generator. In an embodiment, the system 100 may optionally include a lens 108 to focus the beam generated by the beam generator 106. Also, the lens 108 may include more than a single lens in some embodiments. Furthermore, the lens 108 may be provided at various locations. For example, the lens 108 may be provided between the beam generator 106 and the photomask 104 (as shown in FIG. 1). Alternatively, the lens 108 may be provided between the photomask 104 and the image capture device 102. Also, in multiple lens systems, one or more of the lenses may be provided between the generator 106 and the photomask 104, between the photomask 104 and the device 102, or any combinations thereof.

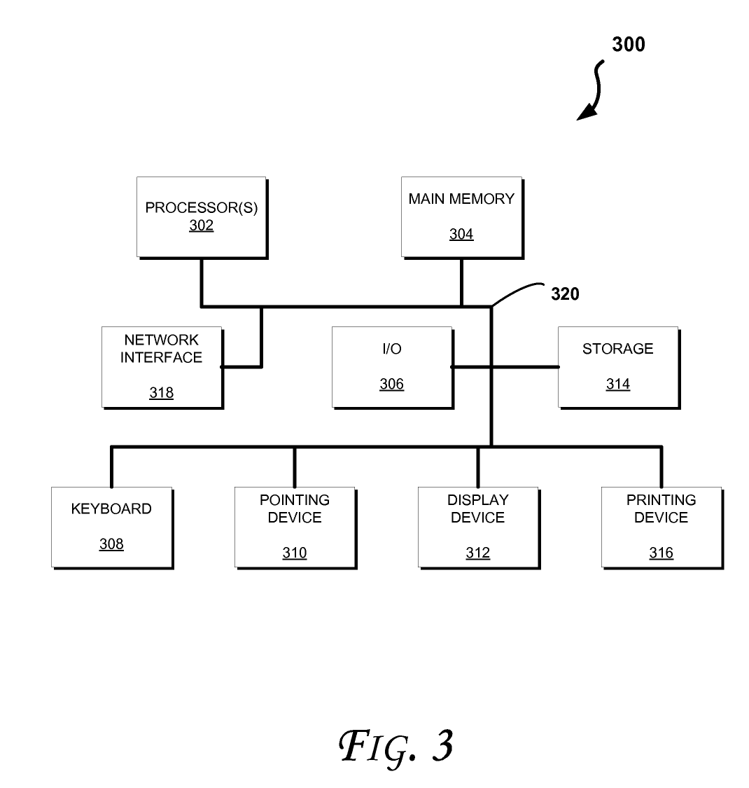

The system 100 may additionally include a computing device 120 to control some or all of the operations of the system 100, as will be further discussed herein, for example, with reference to FIGS. 2 and 3. Alternatively, a standalone computing device (such as that discussed with reference to FIG. 3) may be used to perform reticle analysis offline from reticle inspection system. The computing device 120 may include one or more processors 122, an input/output (I/O) module 124, and/or a memory 126 (which may be a volatile and/or nonvolatile memory). For example, the I/O module 124 may communicate with various components of the system 100, while the processors 122 may process the communicated data and the memory 126 may store the communicated data, as will be further discussed herein, e.g., with reference to FIGS. 2-3. As shown in FIG. 1, the computing device 120 may control and/or communicate with the beam generator 106 and/or the image capture device 102. For example, the computing device 120 may cause the beam generator 106 to generate a beam at a desired wavelength and at a certain time period. Moreover, the computing device 120 may cause the image capture device 102 to capture an image of the photomask 104 for further processing, such as discussed with reference to FIG. 2.

FIG. 2 illustrates a flow diagram of a method 200 to repair mask defects, according to an embodiment. In one embodiment, the method 200 may be used to repair mask defects through wafer plane modeling. Also, various operations discussed with reference to FIG. 2 may be performed by some of the components discussed with reference to FIGS. 1 and 3.

Referring to FIGS. 1-2, at an operation 202, a photomask image is acquired (e.g., using an optical or an electron beam reticle inspection or metrology system such as the system 100 of FIG. 1). At an operation 204, the wafer resist contour may be simulated (e.g., the captured mask image of operation 202 may be simulated to a wafer image at operation 204) to assist in mask edge placement using one or more lithography conditions, e.g., provided by an operator or pre-selected. Lithography conditions may have different Numerical Aperture (NA), Sigma, Dose, Focus, and illumination profiles. In some embodiments, lithography conditions may use annular illumination with inner and outer sigma of about 0.65/0.80 and NA of about 0.85. Dose and focus may be set for optimum results but may vary in production.

At an operation 206, it may be determined whether the simulated wafer resist contour matches the target critical dimension (CD) of the IC design (e.g., which corresponds to a physical layout of the IC design, for example, in Graphics Data System (GDS) format or DGS II format). If the simulated wafer resist contour does not match the target CD, then the mask edge contour may be modified (e.g., perturbed and/or re-optimized) at an operation 208. In an embodiment, operation 208 may modify the mask edge placement such that it simulates the resist contour at the correct edge placement or CD. For example, a line on a photomask with a correct CD may have a simulated wafer CD that is smaller than desired compared to the circuit design. The edge(s) of the line on the photomask may be modified so it is appropriated to meet the required CD on the wafer using mask repair methods. In this case the line on the mask may have met the requirement according to the mask specifications, however the simulated results may have identified a weakness in the mask design (possibly the OPC (optical proximity correction)) and calculated the amount of edge movement required to achieve the required CD on the wafer. Once the operation 206 determines that a contour match is reached, the new photomask may be used at operation 210, e.g., to correct any detected mask errors and/or for IC fabrication. For example, after correcting any detected mask defects, photomasks may be fed into a photolithography stepper or scanner and individually selected for exposure, thereby defining one or more pattern layers on a semiconductor wafer.

In an embodiment, at operation 204, software may be utilized to simulate the wafer resist contours using aerial image modeling and resist modeling. The software then may move the edge of the mask from the original position through some number of iterations until the photomask edge placement delivers the desired wafer contour (e.g., as determined at operation 206). In some embodiments, the number of iterations may be predetermined by a user and/or software (which may continue the iterations until the edge moves within a certain range of target). This approach may provide the ability to optimize the correction of these error locations on the mask to achieve the desired target CD on wafer given the lithography conditions. Hence, operations 204-208 may create a new recommended mask pattern edge placement, which may be different from that provided by the original photomask design data. Some embodiments may also take the spatial resolution of the repair system into consideration when computing the optimum edge placement. Using this new mask pattern edge placement, the errors may be corrected on the mask using conventional mask repair tools. The result may be an optimized photomask pattern at the local site of a photomask's defective location, which may be different from the original mask database, but re-optimized for best CD results on final wafer.

Various types of mask repair tools may be utilized at operation 210 such as: (1) laser ablation used for chrome removal; (2) focused ion beam used for gallium liquid metal ion source for deposition; (3) electron beam for deposition and etching; and/or (4) mechanical nano-machining for material removal. The focused ion beam (FIB) mask repair systems perform ion-induced material deposition to add gallium for pattern reconstruction. The resolution of FIB repair systems is typically 10 nm to 30 nm depending on beam energy. This spatial resolution is not as fine as the original pattern generation of the mask. Therefore, the repair is not expected to deliver the same edge placement accuracy as a pattern generator. By knowing the special resolution limits of a repair system an embodiment of the invention may perturb the edge placement under the specific resolution constraints in order to find the optimum edge placement for the repair system to use as the reference for repair.

Furthermore, in an embodiment, mask repair tools (such as system 100 of FIG. 1) may either deposit or remove material for mask error correction at operation 208. Some of the mask repair systems that add more material to the photomask may be limited in resolution and may benefit from some of the techniques described herein, e.g., by optimizing the repair strategy for optimum wafer resist contour results. Mask repair systems that remove material may also be used in some embodiments of the invention. For example, when using a focused ion beam (FIB) for removal of material, the etch process may leave implanted ions in quartz resulting in a transmission loss at the repair location. This transmission loss may be predictable given the ion beam energy use for repair, and may be used by some embodiments when determining the optimum edge placement of the repair for optimum wafer resist contour.

In an embodiment, various techniques discussed herein (e.g., with respect to operations 202-208) may allow for compensation of the photomask edge placement by taking the expected transmission and phase of the mask repair into consideration before the mask repair is made (e.g., at operation 210), which may result in higher quality mask repairs, less iterations of repairs, fewer rejected repairs, and/or fewer rejected masks. Moreover, some features provided by embodiments of the invention, such those discussed with reference to method 200, may include: (a) creating repair edge placement target based on desired wafer resist contour; (b) creating repair edge placement target based on resolution limitations of the repair system; and/or (c) creating repair edge placement targets based on predicted transmission or phase errors created by the repair system at the repair location.

Some embodiments may enable the ability to: (1) repair OPC (optical proximity correction) and physical layout errors on IC designs present on the photomask after the photomask has been patterned by a pattern generator; (2) optimize the mask repair to achieve the desired wafer feature CD given the resolution limits of the defect repair system; and/or (3) optimize the mask repair to achieve the desired wafer feature CD given the expected transmission and phase error of the repair. On the contrary, current mask repair may only be capable of repairing mask errors, not OPC or physical layout errors on the mask. Mask repair has less spatial resolution than pattern generators and thus defects are not of the quality desired.

FIG. 3 illustrates a block diagram of computer system 300 that may be utilized in various embodiments of the invention. In an embodiment, the system 300 may be utilized instead of or in addition to the computing device 120 in system 100 of FIG. 1. The system 300 may include one or more processors 302, a main memory 304, an input/output (I/O) controller 306, a keyboard 308, a pointing device 310 (e.g., mouse, track ball, pen device, or the like), a display device 312, a mass storage 314 (e.g., a nonvolatile storage such as a hard disk, an optical drive, or the like), and a network interface 318. Additional input/output devices, such as a printing device 316, may be included in the system 300 as desired. As illustrated in FIG. 3, the various components of the system 300 may communicate through a system bus 320 or similar architecture.

In accordance with an embodiment of the invention, the processor 302 may be a complex instruction set computer (CISC) microprocessor, a reduced instruction set computing (RISC) microprocessor, a very long instruction word (VLIW) microprocessor, a processor implementing a combination of instruction sets, or the like.

Moreover, the network interface 318 may provide communication capability with other computer systems on a same local network, on a different network connected via modems or the like to the present network, or to other computers across the Internet. In various embodiments of the invention, the network interface 318 may be implemented by utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), or the like), analog modem, digital subscriber line (DSL and its varieties such as high bit-rate DSL (HDSL), integrated services digital network DSL (IDSL), or the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 300 may utilize operating systems such as Solaris, Windows (and its varieties such as CE, NT, 2000, XP, ME, Vista, or the like), HP-UX, IBM-AIX, PALM, UNIX, Berkeley software distribution (BSD) UNIX, Linux, Apple UNIX (AUX), Macintosh operating system (Mac OS) (including Mac OS X), or the like. Also, in certain embodiments of the invention, the computer system 300 may be a general purpose computer capable of running any number of applications.

In various embodiments of the invention, the operations discussed herein, e.g., with reference to FIGS. 1-3, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any suitable storage device such as those discussed with respect to FIG. 1-3.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

In the description and claims, the terms “coupled” and “connected,” along with their derivatives, may be used. In some embodiments of the invention, “connected” may be used to indicate that two or more elements are in direct physical contact with each other. “Coupled” may mean that two or more elements are in direct physical contact. However, “coupled” may also mean that two or more elements may not be in direct contact with each other, but may still cooperate or interact with each other.

Although embodiments have been described in language specific to structural features and/or methodological acts, it is to be understood that claimed subject matter may not be limited to the specific features or acts described. Rather, the specific features and acts are disclosed as sample forms of implementing various embodiments. While the invention has been described above in conjunction with one or more specific embodiments, it should be understood that the invention is not intended to be limited to one embodiment. The invention is intended to cover alternatives, modifications, and equivalents as may be included within the spirit and scope of the invention, such as those defined by the appended claims.

1. An apparatus comprising:
an image capture device to capture an image of a photomask; and
logic to determine an updated edge location of the photomask based on the photomask image and a simulated contour of a corresponding wafer, wherein the logic is to compare the simulated wafer contour to physical design data of a corresponding device design.

2. The apparatus of claim 1, further comprising a mask repair tool to repair the photomask.

3. The apparatus of claim 2, wherein the mask repair tool comprises one or more of: a laser ablation tool, a focused ion beam tool, an electron beam tool, or a mechanical nano-machining tool.

4. The apparatus of claim 2, wherein the logic is to determine the updated edge location of the photomask based on a spatial resolution of the repair tool.

5. The apparatus of claim 2, wherein the logic is to determine the updated edge location of the photomask based on one or more of a predicted transmission or a predicted phase error created by the repair tool at a repair location, wherein the repair tool is to be used to repair the photomask at the repair location.

6. The apparatus of claim 1, further comprising a pattern generator to generate a pattern on the photomask.

7. The apparatus of claim 1, further comprising a beam generator to generate a beam that is directed to the photomask to allow the image capture device to capture the image.

8. The apparatus of claim 7, wherein the beam is one or more of an optical or an electron beam.

9. The apparatus of claim 7, further comprising one or more lenses to focus the beam.

10. The apparatus of claim 1, further comprising a storage device to store a plurality of values corresponding to the photomask.

11. The apparatus of claim 10, wherein the storage device comprises one or more of a volatile memory or a nonvolatile memory.

12. The apparatus of claim 1, further comprising a photolithography scanner to expose the wafer to the photomask to define one or more pattern layers on the wafer.

13. The apparatus of claim 1, wherein the logic comprises at least one processor.

14. A method comprising:
acquiring a photomask image; and
determining an updated edge location for the photomask based on the photomask image and a comparison of a simulated contour of a corresponding wafer to physical design data of a corresponding device design.

15. The method of claim 14, further comprising determining whether the updated edge location of the photomask matches the contour of the wafer.

16. The method of claim 14, further comprising modifying an edge location of the photomask after a determination that a previous edge location of the photomask fails to match the contour of the wafer.

17. The method of claim 14, further comprising simulating the contour of the wafer.

18. The method of claim 17, wherein the simulating is performed in accordance with aerial image modeling.

19. A computer-readable medium comprising one or more instructions that when executed on a processor configure the processor to perform one or more operations to:
acquire a photomask image; and
determine an updated edge location for the photomask based on the photomask image and a comparison of a simulated contour of a corresponding wafer to physical design data of a corresponding device design.

20. The computer-readable medium of claim 19, wherein the one or more instructions configure the processor to determine whether the updated edge location of the photomask matches the contour of the wafer.

21. The computer-readable medium of claim 19, wherein the one or more instructions configure the processor to modify an edge location of the photomask after a determination that a previous edge location of the photomask fails to match the contour of the wafer.

22. The computer-readable medium of claim 19, wherein the one or more instructions configure the processor to simulate the contour of the wafer.
